(19) United States
(12) Patent Application Publication
(10) Pub. No.: US 2006/0047019 A1
(43) Pub. Date: Mar. 2, 2006

(54) Method of making a road marking material with thermochromic colouring user interfaces

(76) Inventors: Nis Ravnskjaer, Svendborg (DK); Peder Moth, Hesselager (DK); Toni Ogemark, Malmo (SE)

Correspondence Address: WILLIAM J. SAPONE;COLEMAN SUDOL SAPONE P.C., 714 COLORADO AVENUE, BRIDGE PORT, CT, 06605, US

(21) Appl. No.: 10/929,105

(22) Filed: Aug. 27, 2004

(51) Int. Cl. F21V 7/22

(52) U.S. Cl. 523/172

(57) ABSTRACT

When, according to the invention, a thermochromic pigment is added to a generally known road marking basic material, road markings may be established with integrated warning effect in the form of a colour change which is produced at temperatures below 5° C.

This marking material may be used for road stripes (2), points and other markings, just as it may be used for the production of colour changing flat elements (3, 4).

### PRIOR ART

The invention relates to a method of making a road marking material for use in the application of stripe markings and the like, said material being formed by normal road marking material especially a thermoplastic material.

Road marking in the form of edge lines, skip lines (centrelines) and various symbols like arrows, warning triangles etc. are typically made by paint, 2-component materials or thermoplastic. The materials are white but a few countries (like USA) use yellow lines in the left side.

Icy roads are a big risk factor for traffic in many countries. They cause many accidents, loss of lives and high costs. The ice causes very low friction between road and wheels, and the driver must reduce speed drastically to avoid accidents. The problem is that icy roads can occur suddenly, very locally and without warning. Typical zones of danger are bridges, forest areas, low areas, north hilltops etc. The drivers have little chance to be aware of the risk beforehand and to reduce speed in time.

Icy roads can occur when the road temperature goes below about 5° C.

A number of different warning devices are known, many of them based on electronic devices. Their problem is that they are costly and difficult to install. They are therefore only used in small numbers on roads with high traffic.

### OBJECT OF THE INVENTION

The object of the invention is to enhance the road safety where icy roads can occur. This is achieved by using a road marking material which changes colour at temperatures below 5° C. The said change of colour is achieved by adding a thermochromic pigment to the road marking material.

By doing this the road marking will appear as normal at temperatures above 5° C., but where the road temperature locally falls below 5° C. the road marking changes colour (to pink, red, orange or other colours). The change of colour will remain as long as the temperature stays below 5° C. When the temperature rises again the colour will go back to normal white.

When, as stated in claim 2, the basic material and the pigment are mixed prior to application, the marking may be applied to the road surface by means of generally known methods. Thereby you can apply frost warning to big road areas at relatively low costs.

When, as stated in claim 3, the markings are prefabricated, these may be produced with a high precision and thereby at the lowest possible cost, just as the very attachment to the road surface may take place by adhesion or the like to the road surface.

When, as stated in claim 4, prefabricated elements are applied and adhered in a stripe or optionally separately, warning markings may be designed with any desired shape and extent including flat elements to avoid inconveniences in connection with large level differences in proportion to the road surface.

When, as stated in claim 5, the prefabricated elements are applied at the same time as or perhaps following the application of stripe markings, warning elements can be placed as required.

When, as stated in claim 6, a yellow basic material and thermochromic pigment is used which changes to orange/brown at low temperatures, a good contrast is achieved between the colours, which improves the visual distinctness.

Finally, it is expedient, as stated in claim 7, to use a white basic material and pigments which take on a red/pink colour at low temperatures, as this, too, gives a good contrast which is easy to observe, particularly under poor light conditions.

### DRAWINGS

FIG. 1 shows an example of an applied marking with added thermochromic pigment,

FIG. 2 shows a sectional view of the applied marking,

FIG. 3 shows an example of an prefabricated element seen from above at higher temperatures,

FIG. 3a shows the same elements at lower temperatures after a colour change, and

FIG. 4 shows a sectional view of the element seen in the direction IV-IV on FIG. 3 og 3a

### DESCRIPTION OF AN EXEMPLARY EMBODIMENT

The invention will be described more fully, partly a method of making the marking material, and partly an example of an embodiment of a road marking with a description of the method of applying this marking, either in the form of sections or in combination with a stripe marking.

The basic material used is a generally known thermoplastic stripe material which is suitable for machine extrusion or ejection to the road surface to form coherent stripes, sections or points.

Use of thermochromic pigment in thermoplastic in general is not without problems. First of all the nature of thermoplastic requires that it is applied to the road in melted condition (about 200° C.). This is harmful to the thermochromic pigments—they deteriorate at long time by high temperature, so the application must be carefully controlled. Another problem is that thermochromic pigments are relatively costly and sets a limit for the use. It can also be a problem that the whole line has changed colour. What the driver sees and perceives is the contrast between line and road, and this contrast is not so different just by a change of colour on the line in general.

The invention includes a method for a better warning of the driver by means of contrast, a clear and obvious symbol (snowflake) and least but not last the effect of surprise.

The idea is to use preformed thermoplastic in two different formulations—one with thermochromic pigment and one without. The two formulations look exactly identical at temperatures above 5° C.-under 5° C. the one with thermochromic pigment changes colour. The colour contrast between the two should be as high as possible, and none of the colours should be too dark. Dark colours do not have good visibility at night.

Granulates may be added to this basic material in a known manner to increase the reflection and friction/wear strength.

When, according to the invention, also a thermochromic pigment is added and a colour change is selected at temperatures preferably below 5° C., a slippery road warning may be signalled to the drivers directly in the road marking itself.

The pigment is mixed into the basic mass prior to application.

The basic mass may preferably be light, such as white or yellow, and at low temperatures a suitable pigment will take on a red or an orange colour, and since these colours contrast well on a light background, the visual effect of the colour change is enhanced.

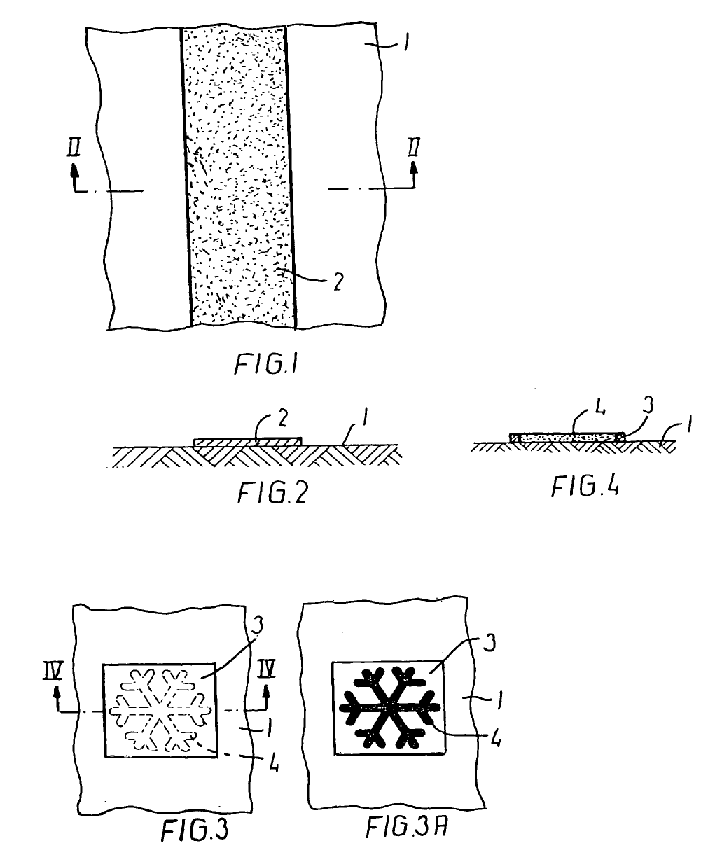

FIGS. 1 and 2 show an example of a road stripe 2 made on the basis of a basic mass into which is mixed a thermochromic pigment.

By way of another example as shown on FIGS. 3 and 4, the starting point of the marking is a section 3 made of a basic material which is suitable for the making of road markings, and to which a thermochromic pigment has been added.

With a suitable selection of pigment, it may be dimensioned to change colour at temperatures below e.g. 5° C. or lower.

A prefabricated element 4 of this type is placed in a surrounding section 3, as indicated in FIGS. 3 and 4.

This second surrounding element 3 is made of a road surfacing mass without colour change.

The two formulations should then be cut into shapes having a good symbolic effect. The driver must be surprised and immediately understand that he is at risk, because of frost, and that he must slow down. One example is a snowflake (thermochromic) hidden in a square (both yellow). Above 5° C. the driver will just see a yellow square. Below 5° C. he will see the snowflake, orange and with a good contrast to the yellow square.

Other examples of “hidden” symbols could be words like “ICE” or “FROST”.

It could also be a hidden speed sign like a normal round “20 mph”.

When these two elements 3, 4 are placed on a road surface 1, they will appear as a generally known marking at temperatures above the selected 5° C. At lower temperatures, the colour change will occur in the marking element 3, which will appear with a colour/reflection.

This colouring will disappear again when the temperature increases above the predetermined colour change temperature.

A warning section 3,4 may be applied or positioned in this simple manner at the desired places on or at the road surface 1.

FIGS. 3 and 3a shows an example of a thermochromic element 4 which is configured as a stylized ice crystal symbol.

This ice crystal symbol will appear clearly in the section at a colour change, and its effect may be enhanced in that the basic colours on the thermochromic section 4 as well as on the surrounding section 3 are yellow. This yellow section will differ from the other markings in the form of stripes, etc., so that the effect of a colour change and thereby an orange or a brown signalling will be optimum.

Where a white marking is desired, pigments taking on a red or pink colour at low temperatures may be added, as explained before.

An example of an ice crystal has been described, but, of course, it is within the scope of the invention to design other symbols. For example, warning signs either in the form of speed limit markings or text and the like are conceivable.

The method of making and applying the marking will be described now.

Where isolated marking sections are involved, these may advantageously be prefabricated in the form of a base plate 3 made of basic material which is provided with a recess into which a separate element 4 can be placed, said element 4 being made of thermochromic material.

The parts 3, 4 may then be applied together or in two stages and be adhered to the road surface 1, or where it might be desired.

There are many possible colour combinations, but as mentioned they must have good contrast and they must be of light colour. The invention suggests yellow base (same colour as used in left edge line in USA) and the thermochromic part changing into orange. Further development of thermochromic pigments might give new possibilities.

Using preformed thermoplastic also adds the advantage of a controlled manufacturing process and thereby reduced risk of destroying the thermochromic pigment because of high temperatures over time.

Both the thermochromic material and the normal material are designed to wear down during traffic. The materials are homogeneous, so even if half or more of the thickness is worn away the warning effect is still maintained.

A kind of prism effect may optionally be incorporated in the configuration of this film layer.

Where application of e.g. warning sections in a central marking is involved, the invention may be worked by performing a generally known stripe application with machinery, following which prefabricated sections 5 are applied at desired places on the stripe in the still liquid marking material, so that the parts may adhere to each other.

This may be done by means of simple equipment which will not slow down the speed of the stripe application machine.

1. A method of making a road marking material for use in the application of stripe markings and the like, said material being formed by normal road marking material especially a thermoplastic material, characterized in that a thermochromic pigment is added to the material, said pigment changing the colour of the total road marking material at temperatures below 5° C.

2. A method according to claim 1, characterized in that the thermochromic pigment is mixed with the basic material prior to the application.

3. A method of applying a road marking according to claims 1 and 2, characterized in that the prefabricated thermochromic element (4) and the prefabricated element (3) with a recess corresponding to the element (4) are placed on the road surface (1) such that both elements (3, 4) form a plane coherent surface.

4. A method according to claim 3, characterized in that the prefabricated elements (3, 4) are flexible and have a thickness of 2-5 mm, preferably 2 mm.

5. A method of applying a road marking in the form of a stripe with thermochromic elements, characterized in that the road stripe (2) is applied in a generally known manner at the same time as prefabricated thermochromic elements (3, 4) are pressed/laid down in the selected stripe (2).

6. A road marking made by the method according to any one of claims 1-5, characterized in that both the basic material with thermochromic pigments (2) and the surrounding marking material (2, 3) are yellow at temperatures preferably above 5° C.

7. A road marking made by the method according to any one of claims 1-5, characterized in that both the basic material with thermochromic pigments (4) and the surrounding marking material (2, 3) are white at temperatures preferably above 5° C.
